(19) United States
(12) Patent Application Publication
(10) Pub. No.: US 2010/0053024 A1
(43) Pub. Date: Mar. 4, 2010

(54) ANTENNA WITH AN IMPROVED RADIATION PATTERN

(76) Inventors: Mats H. Andersson, Goteborg (SE); Lars Manholm, Goteborg (SE); Martin Nils Johansson, Molndal (SE); Stefan Johansson, Romelanda (SE)

Correspondence Address: ERICSSON INC., 6300 LEGACY DRIVE, M/S EVR 1-C-11, PLANO, TX, 75024, US

(21) Appl. No.: 12/514,422

(22) PCT Filed: Nov. 14, 2006
(86) PCT No.: PCT/SE06/50473

§ 371 Date: Sep. 24, 2009

(51) Int. Cl. H01Q 21/29

(52) U.S. Cl. 343/893

(57) ABSTRACT

An antenna device for a telecommunications system, comprising a first antenna with a first radiation pattern and a second antenna with a second radiation pattern. The radiation patterns give the two antennas different coverage in the vertical plane of the antenna device, and the first and the second antennas are used for diversity purposes. The difference in vertical coverage between the first and the second antenna is such that at least the first null points in the vertical plane of the two radiation patterns do not coincide with each other.

### TECHNICAL FIELD

The present invention relates to an antenna device for a telecommunications system, the antenna device comprising a first antenna with a first radiation pattern and a second antenna with a second radiation pattern.

### BACKGROUND

In wireless telecommunications system, users in a specific geographical region known as a cell are served by a central base station. For wide area coverage base stations, the antenna or antennas of the base station usually have a narrow beam width in elevation in order to obtain maximum antenna gain.

Users close to the base station, at elevation angles outside the main beam of the base station antenna or antennas, will have to rely on antenna side lobes for coverage. Some of these users will inevitably be in elevation directions where the base station antenna pattern has so called “nulls”, i.e. very low gain or no gain at all, if no action has been taken to remedy the nulls.

So called “null filling” is used to improve the situation for users located in positions where they would otherwise be in an elevation direction with a null in the base station antenna radiation pattern.

Without null filling there is a risk of losing the user's connection completely, or, for broadband services, to obtain a significantly reduced bit rate, especially if the user is stationary and there is a low angular spread from the environment.

Conventional solutions for null filling have utilized amplitude tapering and/or phase tapering in elevation over the antenna sub arrays of which the base station antenna or antennas usually are comprised. This obtains the desired null filing, but, however, leads to the loss of peak gain towards the edges of the area which it is desired to cover, in other words the cell.

### SUMMARY

As shown above, there is thus a need for an antenna design which would obtain the desired null filling function explained above, without leading to a deterioration of the coverage at the edges of the area which it is desired to cover with the antenna pattern

This need is addressed by the present invention in that it provides an antenna device for a telecommunications system which comprises a first antenna with a first radiation pattern, and a second antenna with a second radiation pattern, by means of which the two antennas have different coverage in the vertical plane of the antenna device.

In the antenna device of the invention, the first and the second antennas are used for diversity purposes, and the difference in vertical coverage between the first and the second antenna is at least such that the first null points in the vertical direction of the two radiation patterns do not coincide with each other.

Thus, since there are two antennas comprised in the antenna device, and at least their first null points do not coincide with each other, the problem with null filling can be solved by means of the present invention, without the drawbacks of previously used methods.

In one embodiment of the invention, the diversity used is receiver diversity, and in another embodiment, the diversity used is transmitter diversity.

In different embodiments of the invention, the first and the second antennas can have radiation patterns which are the same in the horizontal plane of the antenna device, or which differ from each other in the horizontal plane of the antenna device.

The difference in vertical coverage mentioned above can be obtained by means of the first and second antennas being arranged so that they are separated horizontally from each other, with the radiation pattern of the first antenna being arranged at a first vertical angle with respect to the antenna device, and the radiation pattern of the second antenna being arranged at a second vertical angle with respect to the antenna device, the first and second vertical angles being different from each other.

The difference in vertical angles can be obtained either by means of a difference in the mechanical angle of the antennas with respect to the device, or by using electrical means, such as phase shifters, for introducing a beam tilt in the beam of at least one of said antennas.

The first and second antennas have respective first and second polarizations, which can be the same, or different from each other.

The desired effect of having two antennas with differing null points (at least first null points) can be thus achieved in a number of ways, which will be elaborated upon more in the following.

### BRIEF DESCRIPTION OF THE DRAWINGS

The invention will be described in more detail below, with reference to the appended drawings, in which

FIG. 1 shows the radiation pattern of a previously known antenna, and

FIGS. 2a and 2b show respective first and second embodiments of an antenna according to the invention, and

FIG. 3 shows the radiation pattern obtained by means of the antenna of FIG. 2,b and

FIG. 4 shows a third embodiment of an antenna according to the invention, and

FIG. 5 shows the radiation pattern obtained by means of the antenna of FIG. 4, and

FIG. 6 shows a fourth embodiment of an antenna according to the invention, and

FIG. 7 shows the radiation pattern obtained by means of the antenna of FIG. 6, and

FIG. 8 is a flow chart which shows steps of a method of the invention.

### DETAILED DESCRIPTION

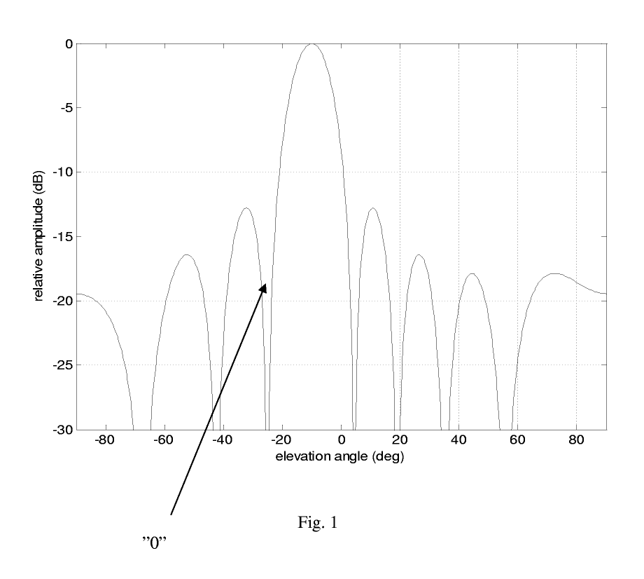

FIG. 1 shows a typical radiation pattern in elevation of a conventional known antenna used in radio base stations. The diagram denoted as FIG. 1 shows the relative radiated power in dB as a function of the elevation angle of the antenna beam which has been electrically tilted to −9 degrees. As can be seen, the radiation pattern comprises a large number of “depths” or null points, i.e. elevation angles in which the radiation pattern has a low gain or no gain at all. One such null point is shown by means of an arrow, said point being denoted as “0”.

It will be realized that if the antenna with the radiation pattern of FIG. 1 is used in a radio base station in a cellular telephony system, users in the system who are in the positions which correspond to the null points can have problems with signal strength.

In order to alleviate the problem with antennas which have null points such as those shown in FIG. 1, the invention provides an antenna device which comprises a first antenna with a first radiation pattern, and a second antenna with a second radiation pattern, with the two radiation patterns giving the two antennas different coverage in the vertical plane of the antenna device.

In the antenna device of the invention, the first and the second antennas are used for diversity purposes, and the difference in vertical coverage between the first and the second antenna at least is such that the first null points in the vertical direction of the two radiation patterns do not coincide with each other.

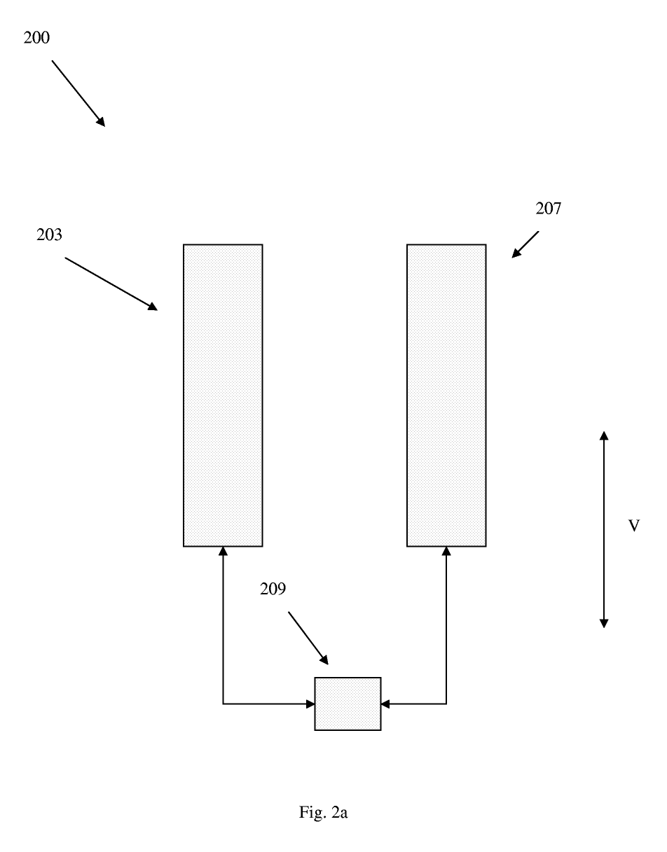

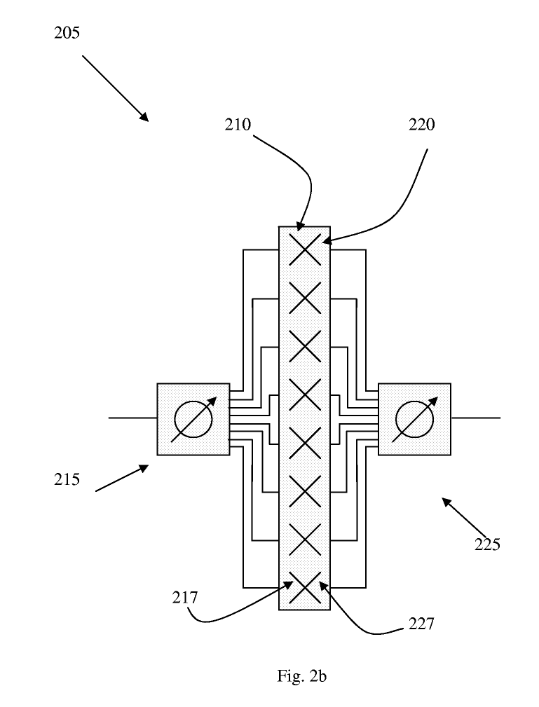

FIG. 2a symbolically shows a first embodiment of an antenna device 200 of the invention. This embodiment 200 comprises a first antenna 203 and a second antenna 207, which are spatially separated from each other, and each of which has a radiation pattern.

In the antenna device 200, the first 203 and the second 207 antennas are used for diversity purposes, by means of a diversity combiner symbolically shown as 209.

In order to obtain the desired “null fill” effect, the first 203 and the second 207 antennas are arranged so that they have different coverage in the vertical plane of the antenna device, a plane which is symbolically indicated by means of an arrow “V” in FIG. 2a. The difference in vertical coverage between the first and the second antenna is at least such that the first null points in the vertical direction of the two radiation patterns do not coincide with each other.

Naturally, the fewer null points that coincide with each other the better, and ideally, none of the null points of the two radiation patterns will coincide with each other.

The difference in vertical coverage is, in the embodiment 200 of FIG. 2a, achieved by means of mechanical tilting of at least one of the antennas 203, 205. Naturally, as will be shown in later embodiments, one or both of the radiation patterns can also be tilted vertically by electrical means.

FIG. 2b shows a second embodiment of an antenna device 205 of the invention. The device 205 comprises a first antenna with a first number of antenna elements 210-217, and a second antenna with a second number of antenna elements 220-227.

As can be seen in FIG. 2b, the antenna elements of the first and second antennas are co-located on one and the same physical “board”, which is not necessary, but which is an expedient solution. As can also be seen in FIG. 2b, the first and second numbers of antenna elements of the respective antennas are equal in this particular embodiment. Each antenna of the antenna device 205 of FIG. 2b comprises eight elements, which is only an example, the number of elements can be varied more or less arbitrarily.

Since the first and the second antennas are co-located, the mechanical tilting of at least one antenna which is used in the embodiment in FIG. 2a cannot be used here. Instead, use is made of different polarizations between the first and the second antennas. Suitably but not necessarily, the polarizations of the first and the second antennas are orthogonal with respect to each other.

In order to achieve the desired effect, i.e. null filling, using orthogonal polarizations between the first and second antennas, the antenna elements of the first and second antennas are arranged orthogonally with respect to one another. Thus, each antenna element 210-217 of the first antenna corresponds to one antenna element 220-227 of the second antenna, each antenna element of the two antennas being arranged in a “cross” with an antenna element from the other antenna, and each antenna element being arranged in a direction which will be ±45 degrees with regard to a vertical line when the antenna device 205 is installed.

It can be pointed out here that the two polarizations used in the embodiment of FIG. 2b need not be orthogonal with respect to each other, and if use is made of two orthogonal polarizations these need not be the ±45 degree arrangement shown in FIG. 2b, but can be any two polarizations which are orthogonal to each other.

Thus, two antennas are comprised in the device 205, each of said two antennas having orthogonal polarization with respect to the other antenna. In order to ensure the desired effect of non-coinciding nulls of the radiation patterns of the two antennas, the antenna device 205 also comprises means for introducing a beam tilt in the beam of at least one of the antennas with respect to the beam of the other antenna.

Such means for introducing beam tilt are well known, and can be designed in a variety of ways, including mechanical ones, but in a preferred embodiment, as shown in FIG. 2b, the beam tilt means comprise phase shifters 215, 225, symbolically shown as one unit for each of the two antennas in FIG. 2, which introduce a time delay in signals to and/or from the antenna elements of one of said antennas compared to signals to and/or from the antenna elements of the other of said antennas.

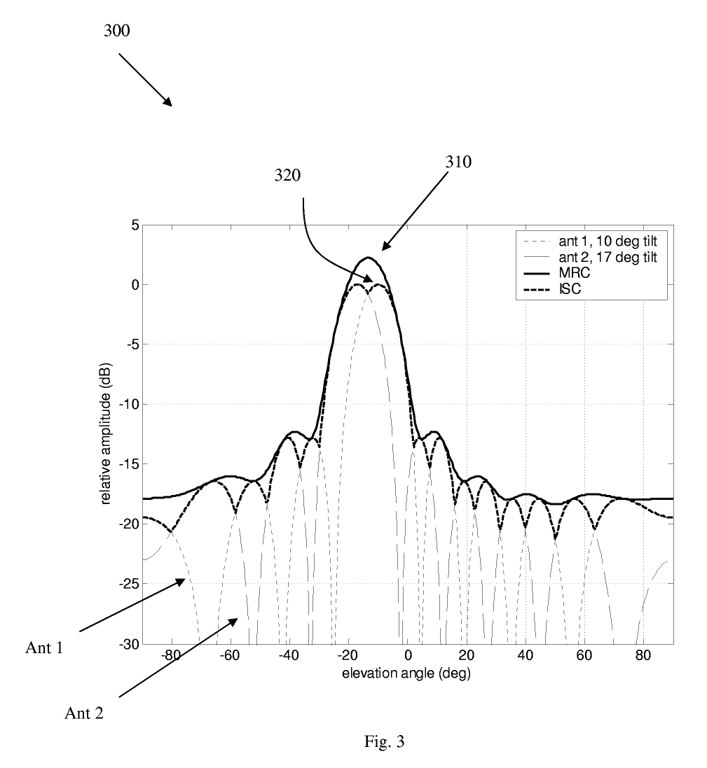

In FIG. 3, a diagram 300 is shown which illustrates the results that can be obtained by means of the antenna device 205 in FIG. 2b. The diagram 300 shows the relative antenna gain in dB as a function of the elevation angle.

The radiation patterns of the two antennas of the antenna device are shown in FIG. 3, indicated as “Ant 1” and “Ant 2” respectively, with the first antenna, “Ant 1”, being tilted at 10 degrees with respect to a horizontal plane as seen when the antenna device is installed, and with the second antenna, “Ant 2”, being tilted at 17 degrees with respect to the same horizontal plane. The tilt angles are obtained by means of the phase shifter or shifters 215, 225, shown in FIG. 2b.

As indicated previously in connection with the description of the arrangement in FIG. 2a, the signals which are received by the two antennas of the antenna device of the invention can be combined in a means for diversity reception. Different principles can be used in such a diversity reception system, the results of two such principles being illustrated in FIG. 3. These two principles are Maximum Ratio Combining, MRC, and Ideal Selection Combining, ISC.

The effective radiation pattern obtained by means of MRC is shown in the diagram and indicated by means of the arrow 310, and the effective radiation pattern obtained by means of ISC is indicated by means of the arrow 320.

As can be seen in FIG. 3, significant improvements can be made with respect to null filling using the antenna device 400 of the invention.

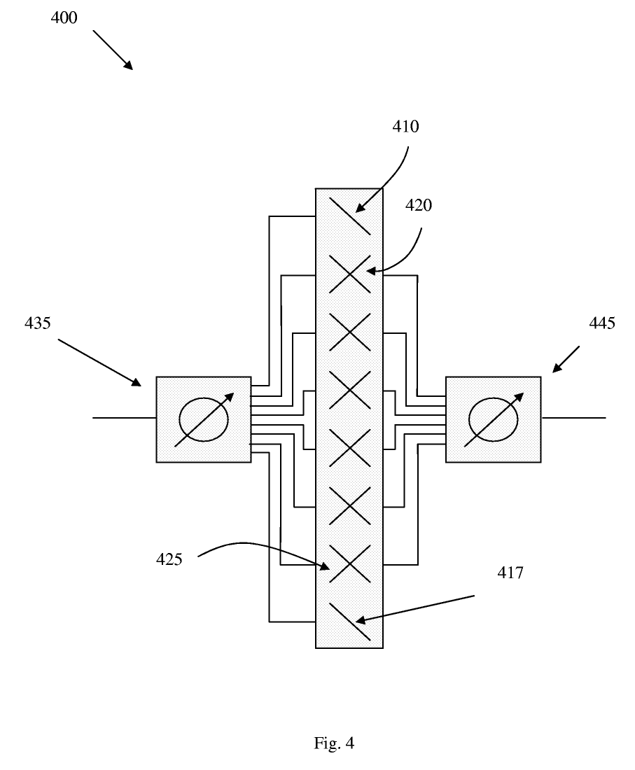

In FIG. 4, a second embodiment 400 of the antenna device of the invention is shown. The antenna device 400 shown in FIG. 4 comprises a first number, 410-417, of antenna elements with one and the same first polarization, which antenna elements constitute the first antenna of the antenna device 400. The antenna device 400 also comprises a second number 420-425 of antenna elements of one and the same second polarization, said second number of antenna elements constituting the second antenna of the antenna device 400.

As is also indicated in FIG. 4, the antenna elements of the first and second antennas are co-located on one and the same physical “board”, which is suitable, but not absolutely necessary for the function of the antenna device 400.

It should be pointed out here that although the embodiment 400 of FIG. 4 is shown as comprising phase shifters 435, 445 for each of the first and second antennas, the phase shifters are, strictly speaking, not necessary for the function of the antenna device 400, as will be explained below.

The antenna elements 410-417 of the first antenna are arranged in “crosses” with the antenna elements 420-425 of the second antenna, said crosses being arranged in an equidistant column in a vertical line, where the term “vertical” is used with reference to how the antenna device 400 is intended to be installed. However, in order to obtain the effect of non-coinciding null points between the first and the second antenna, said first and second numbers of antenna elements are different from each other.

In the example of FIG. 4, the first antenna comprises two elements more than the second antenna, which is merely an example intended to illustrate a general principle.

Since the two antennas are, in effect, of different sizes, they will have differing radiation patterns, and accordingly, also non-coinciding nulls.

All of the elements of the first and second antenna are arranged equidistantly, even those elements in the first antenna that do not have a corresponding element in the second antenna, which is not necessary, but which is a suitable design.

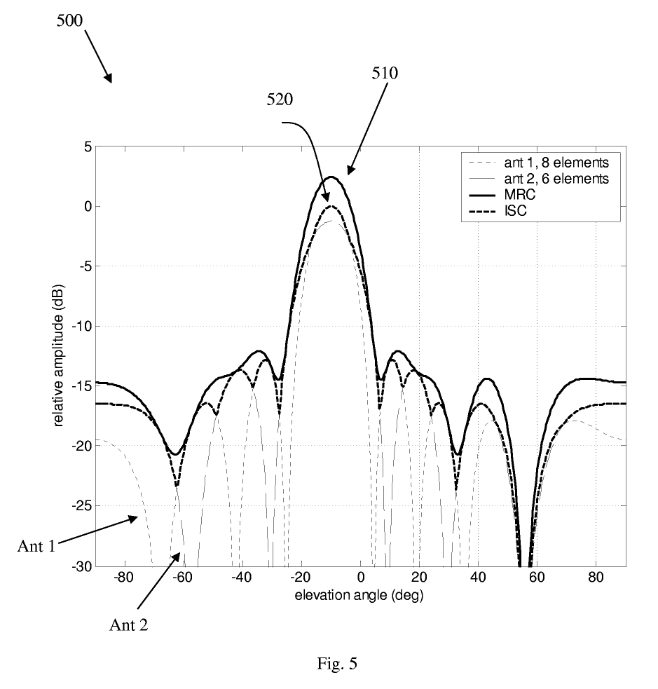

FIG. 5 shows a diagram 500 which illustrates the results that can be obtained by means of the antenna device 400 in FIG. 4. The diagram 500 shows the relative antenna gain in dB as a function of the elevation angle. The individual radiation patterns of the first and second antennas are indicated by means of arrows, “Ant 1” and “Ant 2”. The effective radiation patterns which can be achieved using the antenna device 400 of FIG. 4 by means of the diversity principles mentioned above, MRC and ISC, are also shown in FIG. 5, MRC being shown by means of the arrow 510, and ISC by means of the arrow 520.

As explained in conjunction with FIG. 4, the first and second antennas of the embodiment 400 have different numbers of antenna elements. The number of antenna elements in the first and second antennas can vary from those shown in FIG. 4, but the diagram 500 of FIG. 5 is for an antenna device in which the first and second antennas have the number of antenna elements shown in FIG. 4, i.e. a first antenna with eight radiation elements and a second antenna with six radiation elements.

As can be seen in FIG. 5, significant improvements can be made with respect to null filling using the antenna device 400 of the invention.

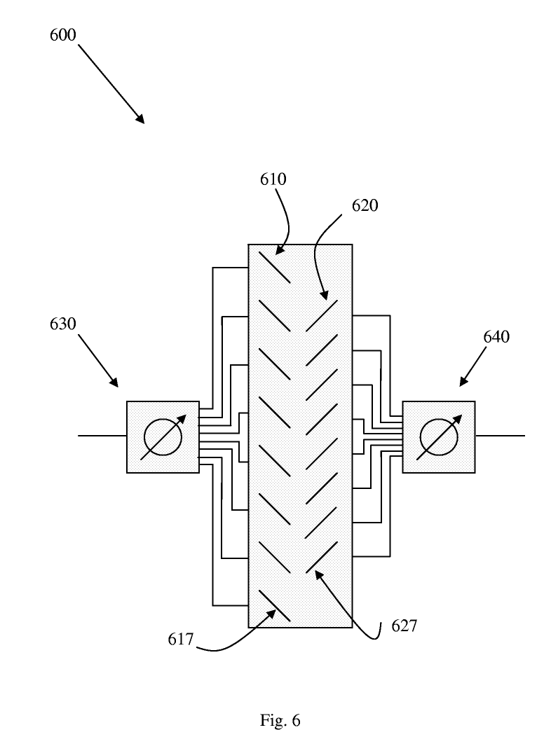

FIG. 6 shows a third embodiment of an antenna device 600 of the invention. In this embodiment, the first antenna comprises a first number of radiation elements 610-617 and the second antenna comprises a second number of radiation elements 620-627. In this embodiment, the first and second numbers are preferably equal, although they can also be different.

In order to obtain the desired effect, i.e. non-coinciding nulls, the radiation elements of each antenna of the device 600 are spaced apart from one another at a first distance for the first antenna and second distance for the second antenna, with said first and second distances being different from each other. As also shown in FIG. 6, the antenna elements 610-617 and 620-627 of the first and second antennas are arranged in respective columns parallel to each other, which is not absolutely necessary in order to achieve the desired effect, but which is a suitable design.

The embodiment 600 of FIG. 6 is also shown as comprising a phase shifter 630, 640, for each of the first and second antennas, which again is a suitable design, but which is not absolutely necessary in order to achieve the desired effect of the non-coinciding nulls, due to the design with equal numbers of radiation elements spaced at differing distances.

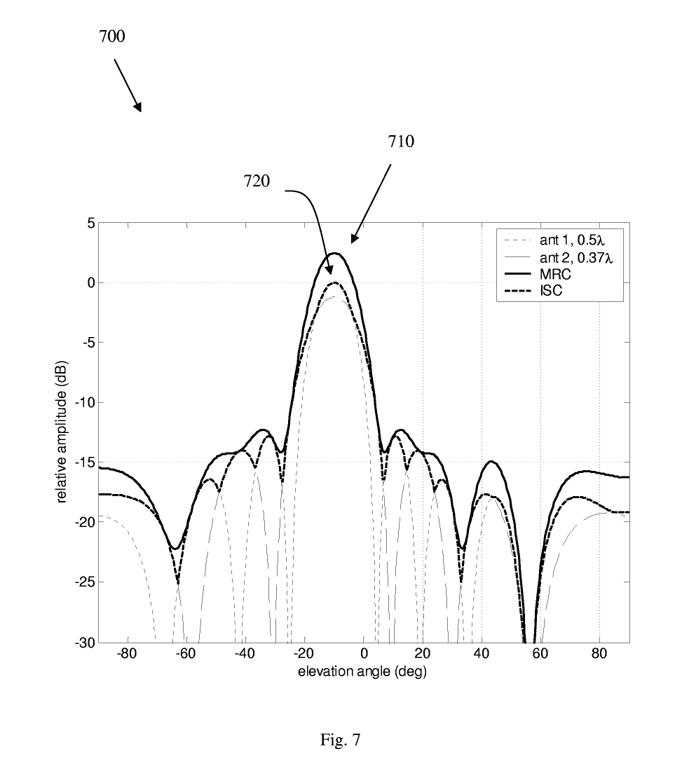

FIG. 7 shows a diagram 700 which illustrates the results that can be obtained by means of the antenna device 600 of FIG. 6. The diagram 700 shows the relative antenna gain in dB as a function of the elevation angle. The individual radiation patterns of the first and second antennas are indicated by means of arrows, “Ant 1” and “Ant 2”. The effective radiation patterns which can be achieved using the antenna 600 of FIG. 6 in both of the diversity principles mentioned above, MRC and ISC, are also shown in FIG. 7, MRC being shown by means of the arrow 710, and ISC by means of the arrow 720.

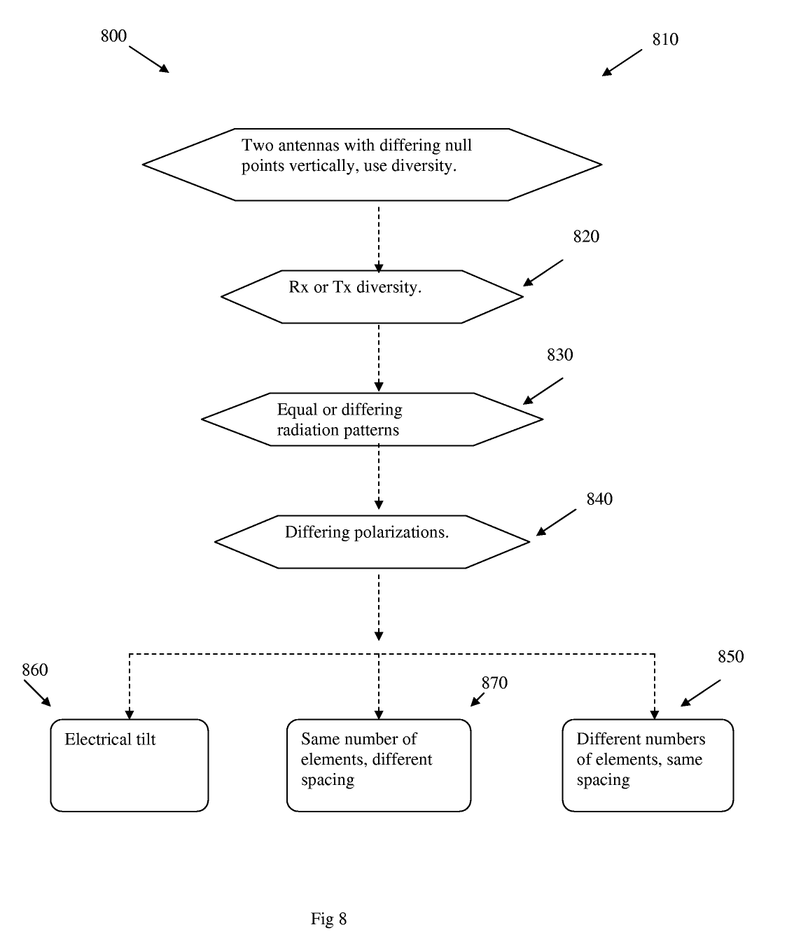

FIG. 8 shows a flow chart 800 which outlines some of the major steps 810-870 of the invention, as described above. Steps which are alternatives to one another or which are options within the invention have been connected to the flow chart by means of dashed lines.

The invention is not limited to the examples of embodiments shown above, but may be freely varied within the scope of the appended patent claims.

For example, although the embodiments shown above have been limited to receiver diversity, the man skilled in the field will realize that the invention can also be applied to transmitter diversity. Also, in the drawings and in the text above, diversity means have only been shown for the embodiment of FIG. 2, but it should be understood that such means may and can be included in all of the embodiments of the invention.

Also, the first and the second antennas may have radiation patterns which are the same in the horizontal plane of the antenna device, or which differ from each other in the horizontal plane of the antenna device.

In addition, a number of principles have been shown in the examples above, such as using two antennas which are spatially separated, or two co-located antennas with different polarizations. Different means for obtaining differences in the vertical coverage have also been shown, such as mechanical or electrical means. Furthermore, antenna devices have been shown which comprise two different antennas, as well as two antennas which are similar. The man skilled in the field will realize that the desired result can be obtained by combining the principles shown in the examples above in a multitude of ways, all of which will be within the scope of the present invention.

What is claimed is:

1-24. (canceled)

25. An antenna device for use in a telecommunications system, the antenna device comprising:
a first antenna with a first radiation pattern; and
a second antenna with a second radiation pattern, said first and second radiation patterns giving the two antennas substantially different coverage in the vertical plane of the antenna device for diversity purposes, wherein the difference in vertical coverage between the first and the second antenna is such that at least first null points in the vertical plane of the first and second radiation patterns do not coincide with each other.

26. The antenna device of claim 25, wherein said diversity is receiver diversity.

27. The antenna device of claim 25, wherein said diversity is transmitter diversity.

28. The antenna device of claim 25, wherein the first and the second antennas have radiation patterns which are substantially the same in the horizontal plane of the antenna device.

29. The antenna device of claim 25, wherein the first and the second antennas have radiation patterns which substantially differ from each other in the horizontal plane of the antenna device.

30. The antenna device of claim 25, wherein said difference in vertical coverage is obtained by means of the first and second antennas being arranged such that they are separated from each other in the horizontal direction of the device, with the radiation pattern of the first antenna being arranged at a first vertical angle with respect to the antenna device, and the radiation pattern of the second antenna being arranged at a second vertical angle with respect to the antenna device, said first and second vertical angles being substantially different from each other.

31. The antenna device of claim 30, wherein said difference in vertical angles is obtained by means of a difference in the mechanical angle of the antennas with respect to the device.

32. The antenna device of claim 30, wherein said difference in vertical angles is obtained by electrical means, such as phase shifters for introducing a beam tilt in the beam of at least one of said antennas.

33. The antenna device of claim 25, wherein the first and second antennas have respective first and second polarizations, said first and second polarizations being different from each other.

34. The antenna device of claim 33, wherein said first and second polarizations are orthogonal to one another.

35. The antenna device of claim 25, wherein the first antenna comprises a first number of antenna elements, and the second antenna comprises a second number of antenna elements, said first and second numbers being different from each other.

36. The antenna device of claim 25, wherein the first and the second antenna comprise equal numbers of antenna elements, and with the antenna elements of each antenna being spaced apart from one another at a first distance for the first antenna and a second distance for the second antenna, said first and second distances being different from each other.

37. A method for use in an antenna device in a telecommunications system, the method comprising the steps of:
using a first antenna with a first radiation pattern;
using a second antenna with a second radiation pattern, said first and second radiation patterns giving the two antennas different coverage in the vertical plane of the antenna device for diversity purposes; and
arranging the first antenna with respect to the second antenna to cause the difference in vertical coverage such that at least first null points in the vertical plane of the two radiation patterns do not coincide with each other.

38. The method of claim 37, wherein said diversity is receiver diversity.

39. The method of claim 37, wherein said diversity is transmitter diversity.

40. The method of claim 37, further comprising the step of arranging the first antenna with respect to the second antenna such that they have radiation patterns which are substantially the same in the horizontal plane of the antenna device.

41. The method of claim 37, further comprising the step of arranging the first antenna with respect to the second antenna such that the radiation patterns substantially differ from each other in the horizontal plane of the antenna device.

42. The method of claim 37, further comprising the step of obtaining the difference in vertical coverage by:
arranging the first and second antennas so that they are separated horizontally from each other, with the radiation pattern of the first antenna being arranged at a first vertical angle with respect to the antenna device, and the radiation pattern of the second antenna being arranged at a second vertical angle with respect to the antenna device, said first and second vertical angles being substantially different from each other.

43. The method of claim 42, wherein said difference in vertical angles is obtained by allowing a difference in the mechanical angle of the antennas with respect to the device.

44. The method of claim 42, wherein said difference in vertical angles is obtained by using electrical means, such as phase shifters, for introducing a beam tilt in the beam of at least one of said antennas.

45. The method of claim 37, wherein the first and the second antennas are chosen with respective first and second polarizations, said first and second polarizations being different from each other.

46. The method of claim 45, wherein said first and second polarizations are orthogonal to one another.

47. The method of claim 37, wherein the first antenna has a first number of antenna elements, and the second antenna has a second number of antenna elements, said first and second numbers being different from each other.

48. The method of claim 37, wherein the first and the second antennas are designed to comprise equal numbers of antenna elements and according to which the antenna elements of each antenna are spaced apart from one another at a first distance for the first antenna and a second distance for the second antenna, said first and second distances being different from each other.
